(19) United States
(12) Patent Application Publication
(10) Pub. No.: US 2009/0006315 A1
(43) Pub. Date: Jan. 1, 2009

(54) STRUCTURED METHOD FOR SCHEMA MATCHING USING MULTIPLE LEVELS OF ONTOLOGIES

(76) Inventors: Sougata Mukherjea, New Delhi (IN); Girish B. Chafle, New Delhi (IN); Sunil Goyal, Gurgaon (IN); Sumit Mittal, Noida (IN); Himanshu Agrawal, Sikandrabad U.P. (IN)

Correspondence Address: FREDERICK W. GIBB, III;Gibb & Rahman, LLC, 2568-A RIVA ROAD, SUITE 304, ANNAPOLIS, MD, 21401, US

(21) Appl. No.: 11/770,859

(22) Filed: Jun. 29, 2007

(51) Int. Cl. G06F 17/30

(52) U.S. Cl. 707/2; 707/E17.125

(57) ABSTRACT

A structured method of matching schemas that uses multiple levels of ontologies is disclosed. The method maps functions of a target system to a process ontology and maps functions of a source system to the process ontology to produce a first mapping of target functions and source functions using the process ontology. The method identifies target function parameters upon which the target functions operate and identifies source function parameters upon which the source functions operate. Then, the method maps the target function parameters to a concept ontology and maps the source function parameters to the concept ontology to produce a second mapping of the target function parameters and the source function parameters using the concept ontology. This second mapping is enhanced by mapping the target function parameters to a data-type ontology and mapping the source function parameters to the data-type ontology. This produces an enhanced second mapping of the target function parameters and the source function parameters using the data-type ontology. This enhanced second mapping can be the resultant output to be used in subsequent processing.

### BACKGROUND AND SUMMARY

The embodiments of the invention generally relate to schema matching, and, more particularly, to a method of matching schemas that maps schema elements of a target system and a source system using multiple levels of ontologies.

Schema matching is a basic problem in many database application domains and has practical applications like legacy system migration, information integration, e-commerce, data warehousing, and semantic query processing. One fundamental operation in schema matching is to take two schemas as input and produce a mapping between elements of the two schemas that correspond semantically to each other.

Independent software vendors such as International Business Machines (IBM), Armonk, N.Y., USA have come up with tools like Rational Data Architect (RDA) that provide automated support for schema matching. However, these tools offer algorithms that are very generic in nature. Therefore, in many current implementations (e.g. data migration in billing consolidation for telecommunications companies) schema matching is typically performed manually, perhaps supported by a graphical user interface. Manually specifying schema matches requires complete knowledge of the data and is a tedious, time consuming, and error-prone process that is, therefore, expensive. With more and more legacy systems to migrate, an increasing number of web data source, and E-businesses to integrate, schema matching is a growing problem.

A plethora of researchers have studied the problem of schema matching and suggested techniques for matching schemas automatically. These can be broadly classified as Schema information based matching and Data instance based matching. Schema information based matchers only consider schema information, not instance data. The schema information includes the usual properties of the schema elements, such as name, description, data-type, relationship types (part-of, is-a, etc.), constraints, and schema structure. Data instance based matchers, on the other hand, use data instances to get important insight into the contents and meaning of schema elements. This is especially useful when schema information is limited, as is often the case for semi structured data.

Conventional schema matching algorithms that are based on general (not domain specific) schema matching techniques are too generic, and do not take advantage of using domain specific information. This results in generation of a lot of incorrect mappings.

The term domain can refer to an industry, an application, a geography etc. For example, industry verticals like Banking and Insurance can be considered as a domain. Similarly, applications for Billing, Customer Relationship Management, Accounting can also be referred to as a domain. Further, geographies corresponding to specific regions, countries or Continents can be classified as a domain. Domain knowledge can be captured in various forms, like an Ontology, a Thesaurus, and a set of Rules. Ontology is used to store domain specific concepts like Customer, Bill etc. and the relationships among them. Thesaurus, on the other hand, is used to store synonyms and abbreviations used in a particular domain. For example, customer can be treated to be the same as party in the Telecom domain. A rule is another way of capturing domain knowledge and can be specified for an industry, for an application, or for geography. Industry specific rules are applicable to the whole industry, e.g. Telecom, and are agnostic to the application. For example, a mobile SIM card number is a 20 digit integer in Telecom. Similarly, application specific rules correspond to a particular IT application, like Billing, CRM etc. For instance, bill generation period can only be fortnightly, monthly, or quarterly for a billing application. Geography specific rules are for a particular geography. For example, the postal code in India is a 6 digit integer.

There have been attempts to improve schema matching by using domain knowledge. This has included use of a corpus of known schemas and mappings as well as utilization of domain integrity constraints. A formal ontology of domain has also been used for semantic mapping connecting the schema describing the data to the ontology. However, ontology has been used only for the concepts in the domain. No attempts have been made to use the process ontology or the data-type ontology, either stand-alone or in a structured combination. In essence, there is no logical organization and use of understanding of the domain in terms of functionalities available (for example, a telecom billing domain has functionalities like PayBill, AddCustomer, RedeemPoints, etc.), classification of entities into concepts, etc.

This disclosure presents a method that uses multiple levels of ontology in a logical structured manner to improve schema matching. This method builds on existing schema matching algorithms and techniques of semantic mapping using domain knowledge.

In one specific embodiment herein, the method of matching schemas maps functions of a target system to a process ontology and maps functions of a source system to the process ontology to produce a first mapping of target functions and source functions to the process ontology. The mapping of the functions partitions the target system and the source system into corresponding subsets of functions. The method identifies parameters upon which the target functions operate and identifies parameters upon which the source functions operate. Then, the method maps the target function parameters to concept ontology and maps the source function parameters to the concept ontology to produce a mapping of the target function parameters (parameters are also referred as schema elements) and the source function parameters to the concept ontology. The concept ontology is domain specific in that it represents industry, application or geography knowledge. This schema element mapping is then enhanced by mapping the target function parameters to a data-type ontology and mapping the source function parameters to the data-type ontology. This produces an enhanced schema mapping of the target function parameters and the source function parameters to the concept ontology. This enhanced second mapping can be the resultant schema matching output.

These and other aspects of the embodiments of the invention will be better appreciated and understood when considered in conjunction with the following description and the accompanying drawings. It should be understood, however, that the following descriptions, while indicating embodiments of the invention and numerous specific details thereof, are given by way of illustration and not of limitation. Many changes and modifications may be made within the scope of the embodiments of the invention without departing from the spirit thereof, and the embodiments of the invention include all such modifications.

### BRIEF DESCRIPTION OF THE DRAWINGS

The embodiments of the invention will be better understood from the following detailed description with reference to the drawings, in which:

FIG. 1 is a flow diagram illustrating a method embodiment;

FIG. 2 is a schematic diagram illustrating the use of a process ontology in embodiments herein;

FIG. 3 is a schematic diagram of the parameters of one matched function subset within source and target systems according to embodiments herein;

FIG. 4 is a schematic diagram illustrating the use of a concept ontology in embodiments herein;

FIG. 5 is a schematic diagram illustrating the use of a data-type ontology in embodiments herein; and

FIG. 6 is a schematic diagram of a system embodiment.

### DETAILED DESCRIPTION OF EMBODIMENTS

The embodiments of the invention and the various features and advantageous details thereof are explained completely with reference to the accompanying drawings. It should be noted that the features illustrated in the drawings are not necessarily drawn to scale. Descriptions of well-known components and processing techniques are omitted so as to not unnecessarily obscure the embodiments of the invention. The examples used herein are intended merely to facilitate an understanding of ways in which the embodiments of the invention may be practiced and to further enable those of skill in the art to practice the embodiments of the invention. Accordingly, the examples should not be construed as limiting the scope of the embodiments of the invention.

The embodiments herein address the deficiencies of existing schema matching (domain specific and/or domain independent) techniques by following a logical approach to classification of domain knowledge. More specifically, the embodiments herein provide a top-down method to perform schema mapping using three levels of ontology. The methods herein provide a technique to determine corresponding subsets of the tables relevant for data mapping based on mapped functions between the source and target system, using a process ontology. These tables and their attributes are mapped based on a concept ontology which can have mapping rules associated with each concept. These rules can be industry, application or geography specific. Finally, the mappings thus generated are refined based on a data-type ontology. The data-type ontology captures the various data-types occurring in a domain and can also help in mapping the concepts in the domain to the expected data-types.

The techniques described herein can be used in conjunction with other known techniques and these methods do not require one single person to understand both the source and target systems. The embodiments herein leverage the domain knowledge/information distributed among two sets of people—one for the source system, another for the target.

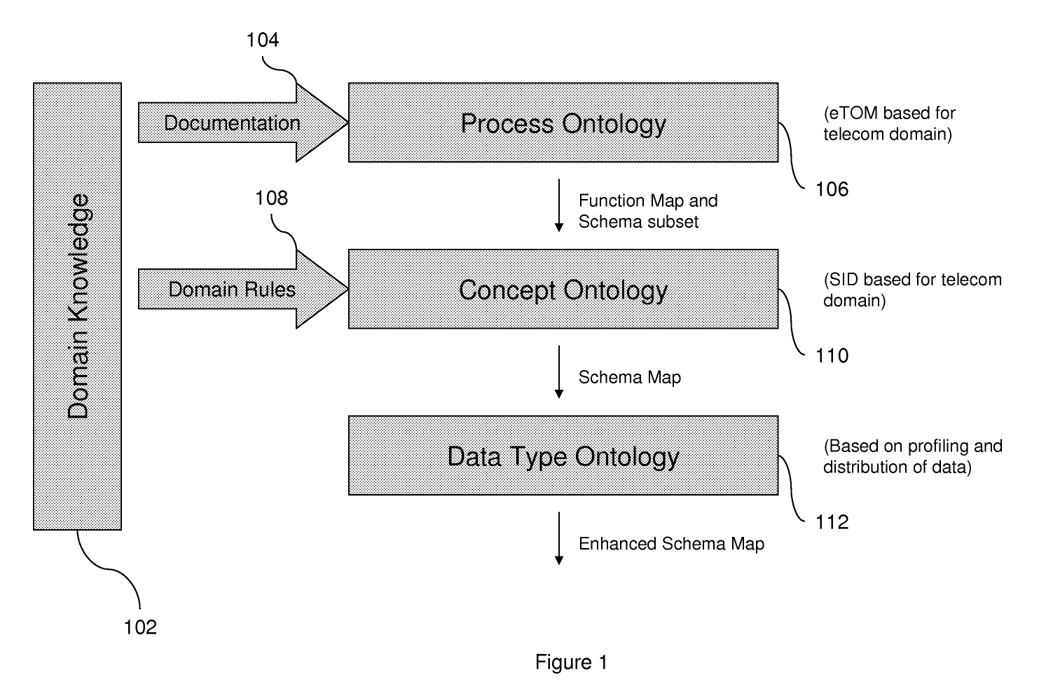

As shown in flowchart form in FIG. 1, the domain knowledge 102 provides documentation 104 for the process ontology 106 of embodiments herein. More specifically, in item 106, the embodiments herein map functions of a target system to a process ontology and map functions of a source system to the process ontology to produce a first mapping of target functions and source functions to the process ontology. The mapping of the functions partitions the target system and the source system into corresponding subsets.

Industry, application and geography rules 108 are obtained from the domain knowledge 102 in order to store with the concept ontology 110 operation of embodiments herein. More specifically, in item 110, the method maps the target function parameters to a concept ontology and maps the source function parameters to the concept ontology to produce a mapping of the target function parameters and the source function parameters to the concept ontology. Additionally, tools like RDA, or domain specific matchers can also be used to generate another set of mappings. Optionally the mapping of parameters can be enhanced by further creating subsets of parameters on the source system and subsets of parameters on the target system and mapping only between the related subsets on the source and targets sides.

Data-type ontology is used to generate another set of function parameter mapping. Thus generated mapping then is used either to filter previously generated function parameter mappings by only selecting repeated overlapping mappings in two, or can be used to augment previously generated mapping with additional mappings found. In item 112, the function parameter mapping is enhanced by mapping the target function parameters to a data-type ontology and mapping the source function parameters to the data-type ontology. This produces an enhanced second mapping of the target function parameters and the source function parameters to the concept ontology. This enhanced second mapping can be the resultant schema matching output.

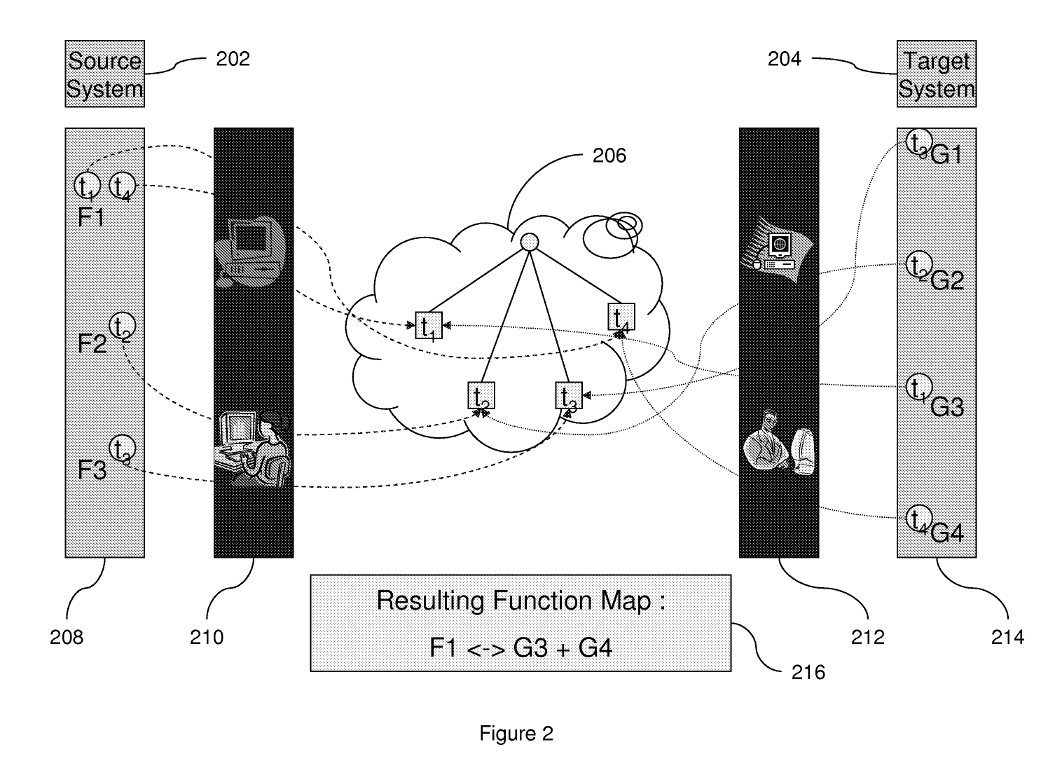

The process ontology aspect of embodiments herein is shown in greater detail in FIG. 2. The process ontology identifies matching functions F1, G3, G4, etc., on source 202 and target systems 204. Items 210 and 212 represent the various user interfaces of the different systems and items 208 and 214 graphically represent the functions F1, F2, etc., and G1, G2, etc. of the source and target systems. The process ontology is provided with the inventive system and is based on industry standards (for ease of use and wider application purposes). E.g., eTOM—enhanced Telecom Operations Map—in telecom domain.

The mapping process is shown as item 206 in FIG. 2. The embodiments herein map functions in target system (G1, G2, etc.) to the process ontology elements (t₁, t₂, etc.). These mappings can be manually specified or (semi-) automatically determined. Similarly, the methods herein map functions in the source system (F1, F2, etc.) to the process ontology elements (t₁, t₂, etc.). This can be either manually entered by the user or (semi-) automatically determined. Further, these mappings represent a one time effort per target system; thus generated mapping can be reused from one assignment to another assignment. As shown by item 216, this process produces a map “Source Function (s) ->Process Ontology <- Target Function (s)” and therefore “Source Function (s) <->Target Function (s)”. Although item 216 in FIG. 2 shows only one function map, other maps such as F2 <->G2 and F3 <->G1 are also generated.

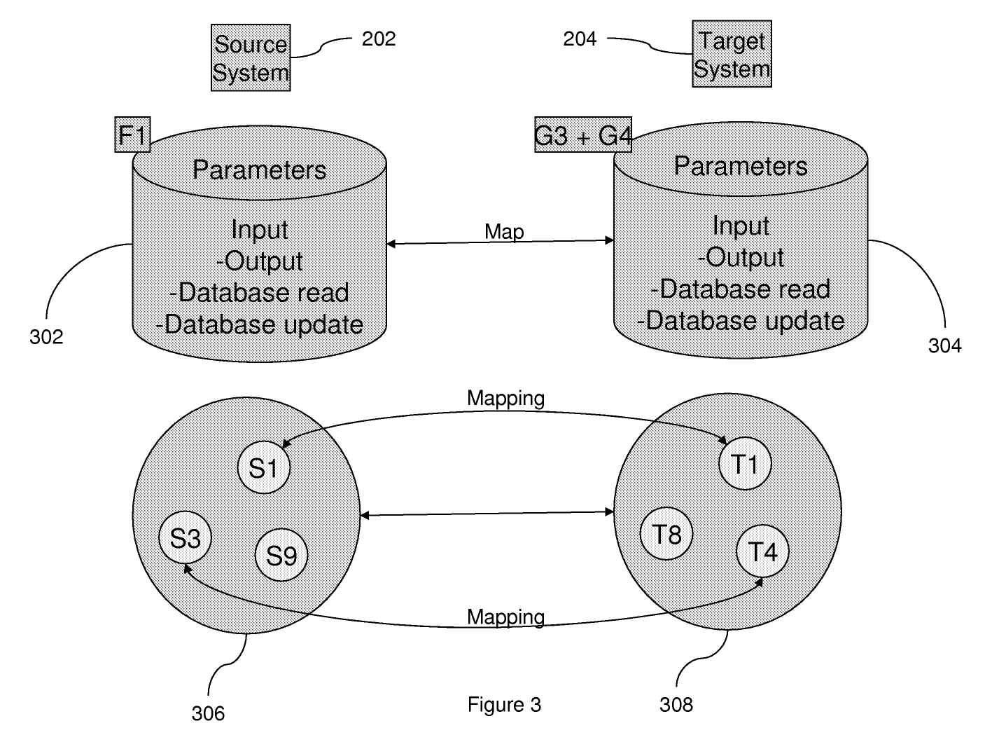

The embodiments herein also identify parameters, and other data elements, for identified functions on source and target systems, as shown in FIG. 3. In FIG. 3, again a subset of source system elements are shown below item 202 and corresponding matching subset (as identified in item 216) of target system elements are shown below item 204. The parameters for the source and target systems are shown as items 302 and 304, respectively and these parameters include but are not limited to input, output, database reads, database updates, etc. For each element in the process ontology (t₁, t₂, etc.), the process gets mapped to the source and target functions (F1, G3, G4). For each function thus obtained, the process determines what all parameters (or data elements) they operate upon. Thus, the process creates a subset of data elements, on the source and target systems, to provide the basis for next level of schema matching.

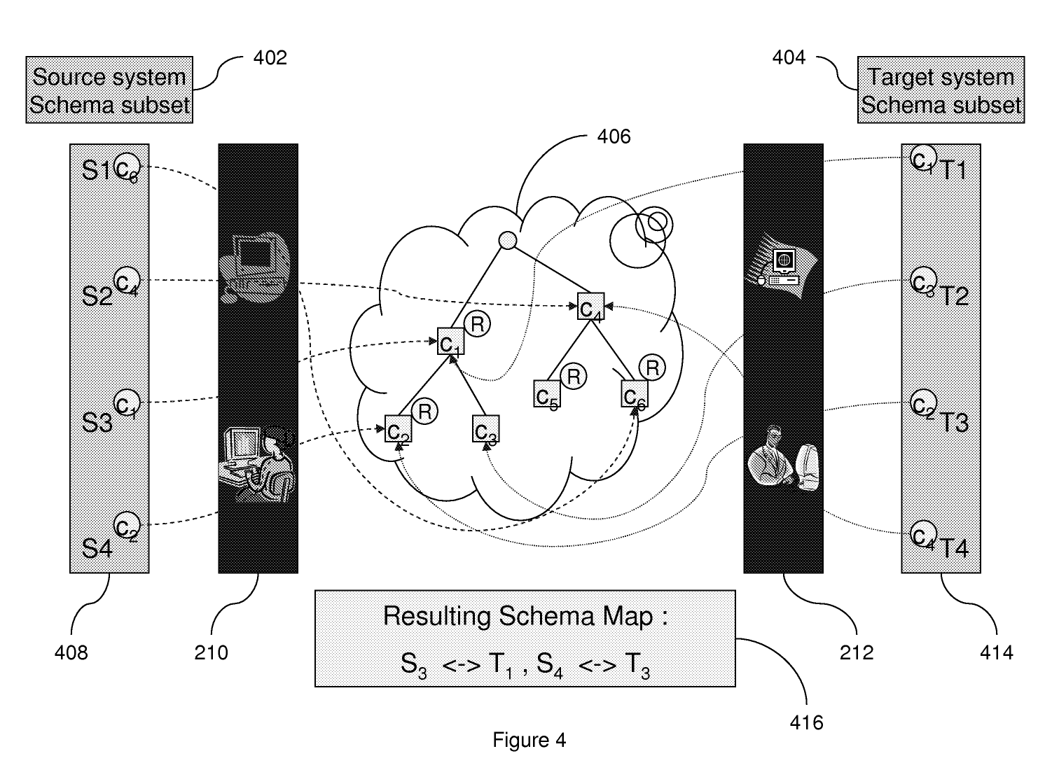

The concept ontology aspect of embodiments herein is shown in greater detail in FIG. 4. In a similar manner to the previous illustrations, the source system schema subset is shown below item 402 and the target system schema subset is shown below item 404. Thus, FIG. 4 illustrates how embodiments herein identify matching data elements (S3, T1), on source and target systems 408, 414, using concept ontology 406. The concept ontology is provided with the inventive system and is generally based on industry standards (for ease of use and wider application purposes). E.g., SID—Shared Information and Data Model—in telecom domain.

In FIG. 4, concepts and the rules attached to concepts are used to determine the mapping in item 406. The embodiments herein map parameters of functions in the target system (T1, T2, etc.) to the concept ontology elements (C₁, C₂, etc.). These mappings can be manually specified or (semi-) automatically determined. Again, this represents a one-time effort per target system. Similarly, the embodiments herein map parameters of functions in source system (S1, S2, etc.) to the concept ontology elements (C₁, C₂, etc.). Again, these can be either manually entered by the user or (semi-) automatically determined. Thus a map 416 is produced “Source Parameter (s) ->Concept Ontology <- Target Parameter (s)” and therefore “Source Parameter (s) <->Target Parameter (s)”. Additionally, existing schema matching algorithms or domain specific mappers can be used on the restricted set of tables from the processing shown in FIG. 3 and can merge the results of this process with the map 416 to provide richer parameter mappings.

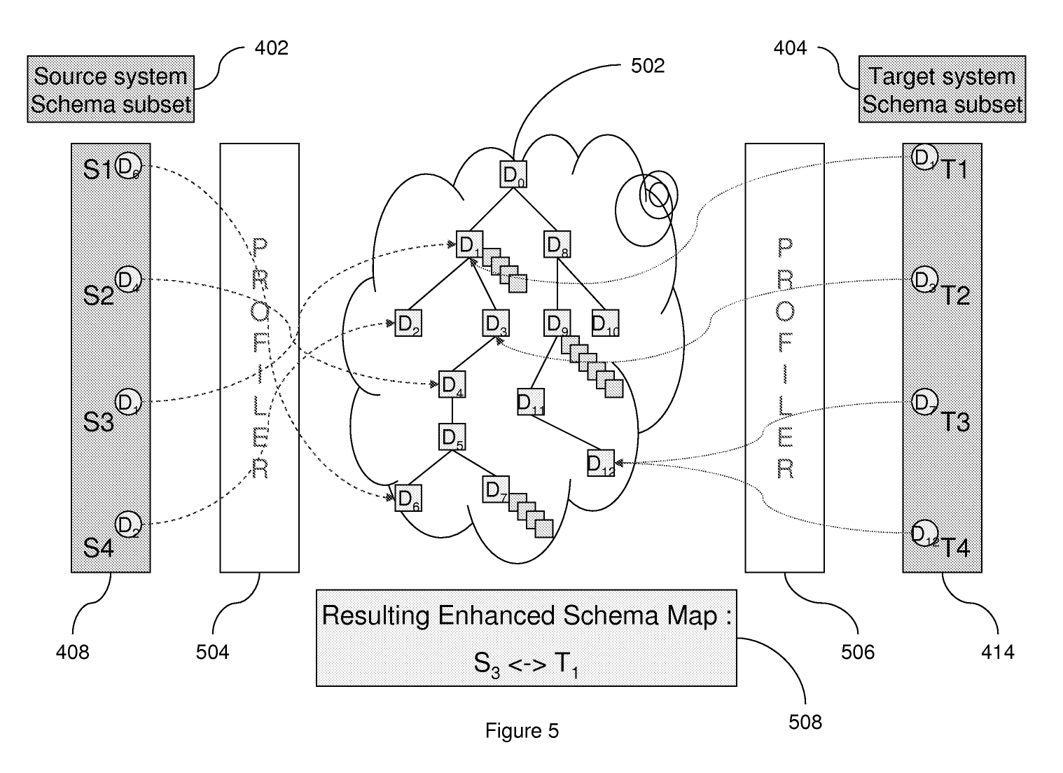

FIG. 5 illustrates the enhancement, validation and filtering of the schema map using the data-type ontology. FIG. 5 is similar in many aspects to FIG. 4, except that the mapping 502 is performed using data-type ontology and therefore profilers 504 and 506 are presented in place of the user interfaces 210 and 212. The resulting enhanced schema map that is shown as item 508. The data-type ontology is provided with the inventive system and is generally close to the target system. The embodiments herein map data elements of target system (T1, T2, etc.) to the data-type ontology elements (D₀, D₁, etc.). These mappings can be manually specified or (semi-) automatically determined. Again, this is a one time effort per target system. The embodiments herein similarly map data elements of source system (S1, S2, etc.) to the data-type ontology elements (D₀, D₁, etc.). This can be either manually entered by the user or (semi-) automatically determined. This produces a map “Source Data Element (s) ->Data-Type Ontology <- Target Data Element (s)” 508 and therefore “Source Data Element (s) <->Target Data Element (s)”. Thus, with embodiments herein, the user can see which ontology concepts match the data elements, based on profiling of the column values. This allows the matches produced by Concept Ontology to be filtered using Data-type Ontology. For example the mapping (S4, T1) suggested by Concept Ontology (FIG. 4) is not suggested by the Data-type Ontology and can be filtered (FIG. 5).

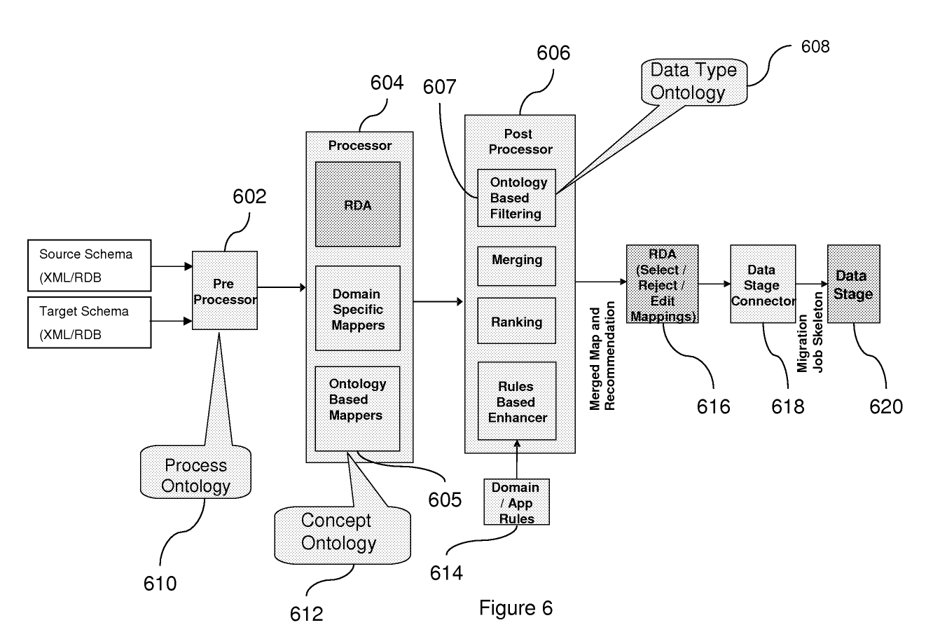

FIG. 6 is one example of one specific embodiment. In FIG. 6, the components include a pre-processor 602, a processor 604, and a post-processor 606. The operation of various aspects of embodiments herein is also shown in FIG. 6. For example, the process ontology 610 is shown as being performed by the pre-processor 602. The concept ontology 612 is shown as being used by concept ontology based mapper 605 of the processor 604 and the data-type ontology 608 is shown as being used by the filtering block 607 of the post-processor 606. Some of the specific elements (RDA and DataStage are available from vendors, such as IBM, Armonk, N.Y., USA).

The pre-processor 602 has access to the source schema and target schema (XML/RDB) and partitions the source and target schemas into smaller matching subsets/segments. Domain specific mappers generate parameter mappings in the processor 604. These mappers are built for different concepts, for example, mappers can be implemented for domain concepts, including Address, Contact, Category, Id and Date. More such mappers can be seamlessly plugged into the embodiments. Ontology based mappers 605 use concept ontology 612 to map function parameter in segments obtained from pre-processor 602. Similarly existing algorithms provided by tools such as RDA can also be used to generate mappings. The post-processor 606 uses domain rules 614, including industry, application, and geography rules, to provide additional mappings. Various mapping results thus far produced using various matching algorithms and techniques are combined using filtering, ranking and merging these results into the final schema map. In this particular embodiment, the filtering is performed by Ontology based filter 607 that uses the data-type ontology 608. The RDA 616 is utilized by the user to select, reject, or edit these mappings. The data stage connector 618 takes the final schema map and generates data stage jobs (migration job skeleton) that can be run by the data stage 620.

The embodiments of the invention can take the form of an entirely hardware embodiment, an entirely software embodiment or an embodiment including both hardware and software elements. In one embodiment, the invention is implemented in software, which includes but is not limited to firmware, resident software, microcode, etc.

Furthermore, the embodiments of the invention can take the form of a computer program product accessible from a computer-usable or computer-readable medium providing program code for use by or in connection with a computer or any instruction execution system. For the purposes of this description, a computer-usable or computer readable medium can be any apparatus that can comprise, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk—read only memory (CD-ROM), compact disk—read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output (I/O) devices (including but not limited to keyboards, displays, pointing devices, etc.) can be coupled to the system either directly or through intervening I/O controllers. Network adapters may also be coupled to the system to enable the data processing system to become coupled to other data processing systems or remote printers or storage devices through intervening private or public networks. Modems, cable modem and Ethernet cards are just a few of the currently available types of network adapters.

The foregoing description of the specific embodiments will so fully reveal the general nature of the invention that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments of the invention have been described in terms of embodiments, those skilled in the art will recognize that the embodiments of the invention can be practiced with modification within the spirit and scope of the appended claims.

What is claimed is:

1. A method of matching schemas comprising:
mapping functions of a target system to a process ontology and mapping functions of a source system to said process ontology to produce a first mapping of target functions and source functions using said process ontology;
mapping target function parameters of said target system to a concept ontology and mapping source function parameters of said source system to said concept ontology to produce a second mapping of said target function parameters and said source function parameters using said concept ontology;
enhancing said second mapping by mapping said target function parameters to a data-type ontology and mapping said source function parameters to said data-type ontology to produce an enhanced second mapping of said target function parameters and said source function parameters using said data-type ontology; and
outputting said enhanced second mapping.

2. The method according to claim 1, wherein said mapping of said functions partitions said target system and said source system into subsets.

3. The method according to claim 2, further comprising identifying parameters belonging to a subset of said source system and said target system.

4. The method according to claim 3, further comprising mapping said parameters of said function subset of said source system to said corresponding parameters of said function subset of said target system, using concept ontology.

5. The method according to claim 3, wherein said parameters of said function subsets of said source system and said target systems are further segmented on the basis of ontology, to create related parameter subsets and only mapping the related parameter subsets of said source and target systems.

6. The method according to claim 4, wherein said concept ontology and domain specific mappers are utilized to create the mappings or subsets.

7. The method according to claim 3, further comprising mapping said parameters of said function subset of said source system to said corresponding parameters of said function subset of said target system, using data-type ontology.

8. The method according to claim 1, wherein said mapping is generated by filtering said mapping generated using concept ontology on the basis of said mapping generated using data-type ontology.

9. The method according to claim 1, wherein said mapping is generated by filtering said mapping generated using data-type ontology on the basis of said mapping generated using concept ontology.

10. The method according to claim 1, wherein said mapping is generated by merging said mapping generated using concept ontology and said mapping generated using data-type ontology.

11. A method of matching schemas comprising:
mapping functions of a target system to a process ontology and mapping functions of a source system to said process ontology to produce a first mapping of target functions and source functions using the said process ontology;
identifying target function parameters upon which said target functions operate;
identifying source function parameters upon which said source functions operate;
mapping said target function parameters to a concept ontology and mapping said source function parameters to said concept ontology to produce a second mapping of said target function parameters and said source function parameters using the said concept ontology;
enhancing said second mapping by mapping said target function parameters to a data-type ontology and mapping said source function parameters to said data-type ontology to produce an enhanced second mapping of said target function parameters and said source function parameters using the said data type ontology; and
outputting said enhanced second mapping.

12. The method according to claim 11, wherein said mapping of said functions partitions said target system and said source system into subsets.

13. The method according to claim 12, further comprising identifying function parameters belonging to a function subset of said source system and said target system.

14. The method according to claim 13, further comprising mapping said parameters of said function subset of said source system to said corresponding parameters of said function subset of said target system, using concept ontology.

15. The method according to claim 13, wherein said parameters of said function subsets of said source system and said target systems are further segmented on the basis of ontology, to create related parameter subsets and only mapping the related parameter subsets of said source and target systems.

16. The method according to claim 14, wherein said concept ontology as well as domain specific mappers can be utilized to create the mappings or subsets.

17. The method according to claim 13, further comprising mapping said parameters of said function subset of said source system to said corresponding parameters of said function subset of said target system, using data-type ontology.

18. The method according to claim 11, wherein said mapping is generated by filtering said mapping generated using concept ontology on the basis of said mapping generated using data-type ontology.

19. The method according to claim 11, wherein said mapping is generated by filtering said mapping generated using data-type ontology on the basis of said mapping generated using concept ontology.

20. The method according to claim 11, wherein said mapping is generated by merging said mapping generated using concept ontology and said mapping generated using data-type ontology.
